(19) United States
(12) Patent Application Publication
(10) Pub. No.: US 2015/0269264 A1
(43) Pub. Date: Sep. 24, 2015

(54) Interactive Real Estate Information Resource Systems And Methods

(71) Applicant: RealAnalogics, Inc., State Line, NV (US)

(72) Inventor: Richard Bolen, State Line, NV (US)

(21) Appl. No.: 14/662,617

(22) Filed: Mar. 19, 2015

Related U.S. Application Data
(60) Provisional application No. 61/968,221, filed on Mar. 20, 2014.

(51) Int. Cl. G06F 17/30; G06Q 30/06

(52) U.S. Cl. CPC G06F 17/30867; G06Q 30/0627; G06Q 50/16

(57) ABSTRACT

An interactive real estate system for facilitating the buying and selling of real estate properties is described. The interactive real estate system includes a standardization engine that is communicatively coupled with a plurality of multiple listing service (MLS) databases. The standardization engine is configured to convert raw MLS data into a standard format and store the standardized data on a standardized MLS database. The interactive real estate system also includes an application engine that is configured to calculate various attributes of the standardized MLS data to facility the buying and selling of real estate properties.

This application claims the benefit of priority to U.S. provisional application 61/968,221 filed on Mar. 20, 2014.

### FIELD OF THE INVENTION

The field of the invention is interactive real estate systems and methods.

### BACKGROUND

The background description includes information that may be useful in understanding the present invention. It is not an admission that any of the information provided herein is prior art or relevant to the presently claimed invention, or that any publication specifically or implicitly referenced is prior art.

National real estate web sites as well as websites at the Multiple Listing Service (“MLS”) broker and real estate agent levels generally are based on a customer finding a real estate property of interest. While some offer a degree of statistical information, such as median sold prices, average list price, and number of sales, such information tends to be incidental to a customer finding a house.

Local and regional information about real estate transactions is maintained in various MLS databases, which are maintained by the various MLS organizations but are only accessible to real estate professionals under various contractual arrangements. Over 880 MLS databases exist in the United States, most of which do not conform to any particular standard. These MLS databases are rich in real estate information, but the respective data structures used in these databases typically are not uniform, and the analytic tools provided by the various MLS organizations are generally quite basic.

An example of a current national real estate web site is www.zillow.com, which provides online comparable prices (“comps”) using relevant house tiers, actual and median prices based on sales and days on market information. While this information is of some utility to the seller to help establish a price, it is a market generalization that does not take into account the seller's objectives. While pricing is known in a general way to affect time-on-market, this general knowledge is insufficient to enable the seller to properly price the property to achieve the seller's objective.

US Patent Application Publication No. 2013/0332313 titled “Electronic Marketplace for Commercial Real Estate” to Bermudez, filed Jun. 10, 2013, describes a system that facilitates commercial real estate transactions by providing an interface through which brokers can post real estate requirements and availabilities. The system also includes a facility that matches requirements and availabilities based on different factors (e.g., deal terms, type of real estate, timing, etc.). Bermudez fails to provide analytical tools that calculate attributes to facilitate the buying and selling of residential real estate properties.

US Patent Application Publication No. 2008/0313225 titled “Methods And Systems For Developing A Data Repository For Heterogeneous MLS Systems” to Spicer et al., filed Jun. 13, 2007, describes a system for mapping MLS data from various sources to a common representation (e.g., format) and saving the data in a repository database. Spicer fails to disclose analytical tools for facilitating the buying and selling of residential real estate properties.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved interactive real estate systems and methods to facilitate the buying and selling of real estate properties.

### SUMMARY OF THE INVENTION

The inventive subject matter provides apparatus, systems and methods in which an interactive real estate system comprises a standardization engine communicatively coupled with a plurality of MLS databases. The standardization engine is configured to receive at least two sets of raw MLS data from at least two MLS databases having two different formats or data schemes. The standardization engine is also configured to convert the first and second sets of raw MLS data into a standard format and store the standardized data on a standardized MLS database.

The interactive real estate system also comprises an application engine configured to calculate at least one attribute of the standardized first and second sets of raw MLS data.

In one aspect of some embodiments, the attribute is an absorption rate.

In other aspects of some embodiments, the attribute is a price characteristic and/or a size characteristic. For example, the price characteristic and/or size characteristic could be one or more of: average age, oldest age, youngest age, average square feet, smallest square feet, largest square feet, average price per square foot, least price per square foot, greatest price per square foot, total number of sales, total number of bank-owned sales, total number of short sales, total number of distress sales, percent of distressed sales, average time to sell, shortest time to sell, and longest time to sell.

In yet other aspects of some embodiments, the attribute is a deal rating. The deal rating can be based in part on a user selection. The deal rating can also be a scaled combination of numerous factors, including: median sold price, price per square foot, average size and average year built for all areas and all square foot and price ranges.

In another aspect of some embodiments, the attribute is an estimated odd of selling (e.g., a likelihood or probability that a property will sell). In some embodiments, the estimated odd of selling can be calculated as a ratio of a total number of homes sold to a total number of homes listed for a given geographical area and temporal period.

In other aspects of some embodiments, the attribute comprises an estimated effect of listing a property at a higher price relative to a lower price. For example, the effect could be calculated as (i) a period of time representing an estimation of how much longer it will take to sell the property at the higher price relative to the lower price, and/or (ii) a price representing an estimation of a difference between a first sold price associated with the higher price and a second sold price associated with the lower price.

The attribute could also be an evaluator characteristic comprising one or more of: house value, spread based on median sold price, estimated sale range, lowest sales price of comparable home, highest sales price of comparable home, lowest price per square foot, highest price per square foot, average price per square foot of all comparable sales, average age, number of comparable homes in an evaluation query, comparable home sales below an estimated sales range, comparable home sales within an estimated sales range, comparable home sales above an estimated sales range, median sold price of all sales within an estimated sales range. The evaluator characteristic can also be specific to a square foot range, year built range, and/or time period.

In other aspects of some embodiments, the can comprise a house cost calculation.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a schematic block diagram of a system architecture 100 for interactive real estate information resource and lead generation for buyers, sellers and real estate professionals.

FIG. 2 shows one embodiment of a GUI for interacting with system 100.

FIG. 3 shows a search listing screen.

FIG. 4 shows an absorption rates screen.

FIG. 5 shows a layout of a spreadsheet of either sales detail or listings details.

FIG. 6 shows a characteristics by price screen.

FIG. 7 shows a characteristics by size screen.

FIG. 8 shows a great deal alert screen.

FIG. 9 shows another great deal alert screen.

FIG. 10 shows an odds of selling screen.

FIG. 11 shows an effects of listing too high screen.

FIG. 12 shows a house cost calculator screen.

FIG. 13 shows an evaluator query screen.

FIG. 14 shows an evaluator results screen.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

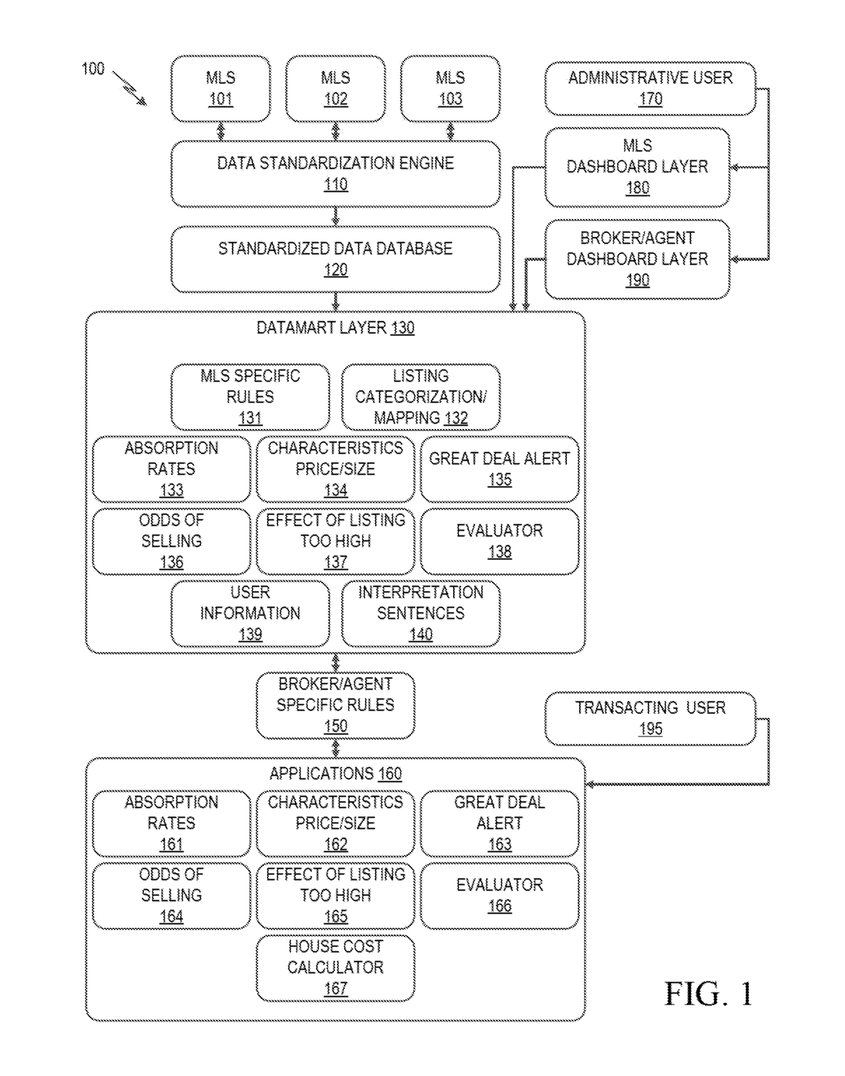

FIG. 1 is a schematic block diagram of a system architecture 100 for interactive real estate information resource and lead generation for buyers, sellers and real estate professionals. The system not only provides a rich variety of relevant and useful real estate information, but also provides insight and guidance into how the real estate information may be used to make pricing decisions in connection with offers to buy and sell specific properties, as well as lead generation for real estate professionals.

The system 100 of FIG. 1 addresses two main concerns commonly voiced by buyers, namely “did I miss anything” and “did I pay too much.” The system of FIG. 1 also addresses a common concern of sellers, namely establishing a listing price that optimally balances price and on-market time. The system 100 is particularly useful when a buyer or seller has identified a property to buy or sell, to interactively guide the buyer or seller to a wise and appropriate decision, along with succinct explanations and as much relevant multiple listing service (“MLS”) supporting information and derived statistics as the buyer, seller, or real estate professional may wish to reference in support of his or her decision.

The system 100 includes a data standardization engine 110 that (i) acquires one or more raw data feeds from one or more different MLS databases such as MLS databases 101, 102 and 103, (ii) converts the raw data feed as necessary into a standardized form for the system 100, and (iii) stores the standardized MLS data in a standardized database 120. A datamart layer 130 is an interpretation layer that has access to the standardized database 120 and performs various calculations and analytical algorithms on the standardized MLS data to create and store various interpretations (e.g., calculation and analytical results) for use by a variety of applications in an application layer 160. The full spectrum of calculations performed may be at least in part determined by an administrative user 170 via MLS dashboard 180. The results are accessible in real time by the various applications in the application layer 160 during interactions with a user 195 who is researching a real estate transaction. The access to the interpretations by the applications 160 is subject to broker/agent specific rules 150. In some embodiments, broker/agent specific rules 150 can be defined by one or more brokers and/or agents via broker/agent dashboard layer 190.

The system 100 may be implemented in one or more application programs running on one or more computers with one or more operating systems, which in the case of multiple computers may be networked in any desired manner using private and/or public wired and/or wireless networks. Suitable computers and their operating systems are well known in the art, and include, for example, mainframe computers, servers, blade servers, workstations, desktop computers, laptop computers, tablets, and smart phones, processors, and various non-transitory electronic storage mediums. The application programs may be written in any of various programming languages. Suitable programming languages are well known in the art, and include COBOL, Fortran, C++, Java and Visual Basic, for example. The standardized database 120, the interpretation data stored in the datamark layer 130, the broker/agent specific rules 150, and the applications data stored in the applications layer 160 may be structured in accordance with one or more data structures and managed by one or more database management systems (“DBMS”), with suitable data structures and DBMS's being well known in the art. The administrative user 170 may access the MLS dashboard layer 180 and the broker/agent dashboard layer 190, and the transacting user 195 may access the applications layer 160, using any type of user interface implemented in the application or in a dedicated user interface program or a general user interface program such as a web browser. Suitable graphical user interface programs are well known in the art and include web browsers such as Internet Explorer available from Microsoft Corporation of Redmond, Wash., USA, the Chrome browser available from Google Inc. of Mountain View, Calif., USA, and the Safari browser available from Apple Inc. of Cupertino, Calif., USA, to name a few.

Data Standardization

The raw data feed is acquired from one or more MLS databases such as 101, 102 and 103 using either pull or push technology. While the raw data feed may be provided in any of a variety of different standards, a suitable standard for real estate data is the Real Estate Transaction Standard (“RETS”). While the desired data may be mined using any of a variety of different query languages, a suitable language for creating data queries is the Data Mining Query Language (“DMQL”).

The data standardization engine 110 converts the raw MLS data feed into standardized data which is stored in the standardized database 120. Suitable data structures and DBMS's for the data standardization engine 110 and the standardized database 120 are well known in the art, and include, for example, the MySQL relational DBMS. One illustrative implementation is for all possible data of interest to be acquired from time to time in a raw data feed and stored in the standardized data database 120. The raw MLS data may be processed to correct or at least identify various errors, inconsistencies, discrepancies, and informalities in the data. Data entry errors such as misspelling and typographical errors may be corrected. Inconsistencies among various MLS databases such as the use of different code terms (such as both “ACT” and “Active” to indicate status) may be converted into standard terms (such as “ACT”). Discrepancies such as between the number of listed versus sold properties may be detected by boundary checking. Informalities such as variations in a place or street name may be corrected.

The standardized data may be updated from time to time either by replacing the raw MLS data with entirely new raw MLS data, or by updating the standardized data. One illustrative updating technique involves acquiring a list of current MLS numbers in a data feed and comparing the list to the MLS numbers in the standardized database 120. MLS records corresponding to numbers missing in the current list may be deleted. MLS records corresponding to numbers present in the current list but missing from the standardized database 120 may be acquired, standardized, and added to the standardized data database 120.

Datamart Layer 130

The various real estate information resources provided to the buyers, sellers, and real estate professionals through interactive user interfaces involve extensive manipulations and calculations of the standardized data in the standardized data database 120. While such data manipulation and calculation may be performed in real time, rather significant processing power or restrictions on the number of users may then be needed to maintain system performance. Responsive system performance with less restriction on user access may be achieved by performing some or all of the principal data manipulations and calculations in advance in a datamart layer 130, and storing the results in the datamart layer 130 for use by various applications 160 to interactively provide the information resources to the buyers, sellers, and real estate professionals.

An MLS specific rules database 131 contains range information for various parameters. Different price range increments (e.g., $25,000 or $50,000 for the larger MLS's and $100,000 for the smaller MSL's) may be specified here. These rules govern the calculations for every MLS.

A listing categorization/mapping module and database 132 populates a database of the listings in a particular MLS along with their respective corresponding price ranges and square foot ranges. Queries based on price range, square foot range, or both may be performed quickly and efficiently on this data set.

An absorption rates module and database 133 (i) calculates the number of homes sold and number of homes on the market for the various price ranges and for various geographical areas, (ii) extrapolates the number of homes sold for various anticipated scenarios such as for various time periods (for example, 30 days, 90 days, 180 days, 270 days, and 365 days), and (iii) estimates the number of months to sell homes on market based on the absorption rates for the various time periods. The results are stored and available for quick and efficient querying.

A characteristics by price/size module and database 134 calculates and stores various data attributes related to price and size for each area and for all price ranges and size ranges, over various periods of time (e.g., 180 days, last seven years). Examples of price/size attributes include the average age, the oldest age, the youngest age, the average square feet, the smallest square feet, the largest square feet, the average price per square foot, the least price per square foot, the greatest price per square foot, the total number of sales, the total number of bank-owned sales, the total umber of short sales, the total number of distress sales, the percent of distressed sales, the average time to sell (days on market), the shortest time to sell, and the longest time to sell. The values of the attributes are stored on a database and are available for quick and efficient querying.

A great deal alert module and database 135 calculates a deal rating. In some embodiments, the deal rating is calculated as a function of median sold price, price per square foot, average size and average year built for all areas and all square foot and price ranges. The results are stored on a database and are available for quick and efficient querying.

An odds of selling module and database 136 calculates and/or estimates, for all areas and price ranges, the odds of selling within various time periods (e.g., 365 days, 180 days, 90 days, etc.). A suitable calculation is the ratio of the number of homes sold to the number of homes listed, expressed as a percentage. The odds of not selling is 100 percent minus the odds of selling. The results are stored in a database and are available for quick and efficient querying.

An effect of listing too high module and database 137 performs various calculations on sold homes. The calculations are performed for various time periods (e.g., less than 90 days, 90-179 days, 180 days and over, etc.). The calculations may be done based on median price, median price excluding distressed properties, number of days on market, number of days on market excluding distressed properties, average list rice, average price per square foot sold, average price per square foot listed, average square feet of home, average year built, average number of bedrooms, percent of homes distressed, and total number of homes sold. Can tell a home buyer the median sold price, how much more money if list home correctly to sell less than 90 days. The results are stored and available for quick and efficient querying.

An evaluator module and database 138 calculates the following for all areas over all square foot ranges and over all year built ranges, and for various time periods (e.g., less than 90 days, 90-179 days, 180 days and over, etc.): house value, spread based on median sold price, estimated sale range (e.g., median sale price plus or minus 12.5K), lowest sales price of comparable home, highest sales price of comparable home, lowest price per square foot, highest price per square foot, average price per square foot of all comparable sales, average age, number of comparable homes in the evaluation (total number within query), comparable home sales below the estimated sales range (expressed in percent and as a number), comparable home sales within the estimated sales range (expressed in percent and as a number), comparable home sales above the estimated sales range (expressed in percent and as a number), median sold price of all sales within the estimated sales range (e.g., 90 days or less, 180 days or more, etc.).

An evaluator module and database 138 may also iterate back to previous calculations, such as the number of listings within estimated sales range, the absorption rate, how long to sell at current absorption rate, the odds of selling for various time periods, and the effects of listing too high, including how much longer to sell and the difference is sold price, if listed too high.

A user information module and database 139 stores user names and profiles including email address and particular areas, square foot range, and price range of interest, or any other information unique to a user.

An interpretation sentences module and database 140 contains a collection of predetermined sentences for interpreting various possible results in the various databases of the datamart 130 in a conversational manner.

Broker/Agent Specific Rules Layer 150

A broker/agent specific rules layer 150 contains rules that are specific to various brokers and agents, such as, for example, the branding header 302 and branding footer 390, and defaults such as specific areas, a specific square foot range, and a specific price range.

Application Layer 160

The application layer 160 performs a number of interactive tasks for a transacting user 195 based on “queries” defined by the transacting user 195 through one or more buyer/seller tools. Each change in a query produces a unique result specific to the new query. These tasks may be performed in one or multiple applications. Illustratively, multiple applications are shown in the illustrative implementation of FIG. 1, specifically an absorption rates application 161, a characteristic price/size application 162, a great deal alert application 163, an odds of selling application 164, an effect of listing too high application 165, an evaluator application 166, and a house cost calculator application 167. While the application layer 160 may provide basic raw MLS data, it advantageously provides interactive, changeable real estate statistics in the form of text and charts, along with “interpretation sentences” in print or audio, or in other media forms as may be useful to the user. The interpretation sentences explain to the buyer or seller what particular real estate information means and why it is important, and guides the buyer or seller as to the appropriate reaction to the information or chart. In essence, these interpretation sentences are a real estate primer and consumer educational resource that make for a better informed and more nuance-aware buyer and seller, as well as giving the buyer or seller a sense of accomplishment and self-confidence. The applications 160 may provide the interactive, changeable real estate data, statistics and interpretation sentences to the buyer or seller for viewing and download, under the real estate professional's own branding, so that the buyer or seller associates not only the comprehensive data but also the insightful evaluations and guidance with the particular real estate professional. This association helps build and reinforce credibility, trust and loyalty, thereby distinguishing the real estate professional and ultimately driving sales and post-sale satisfaction.

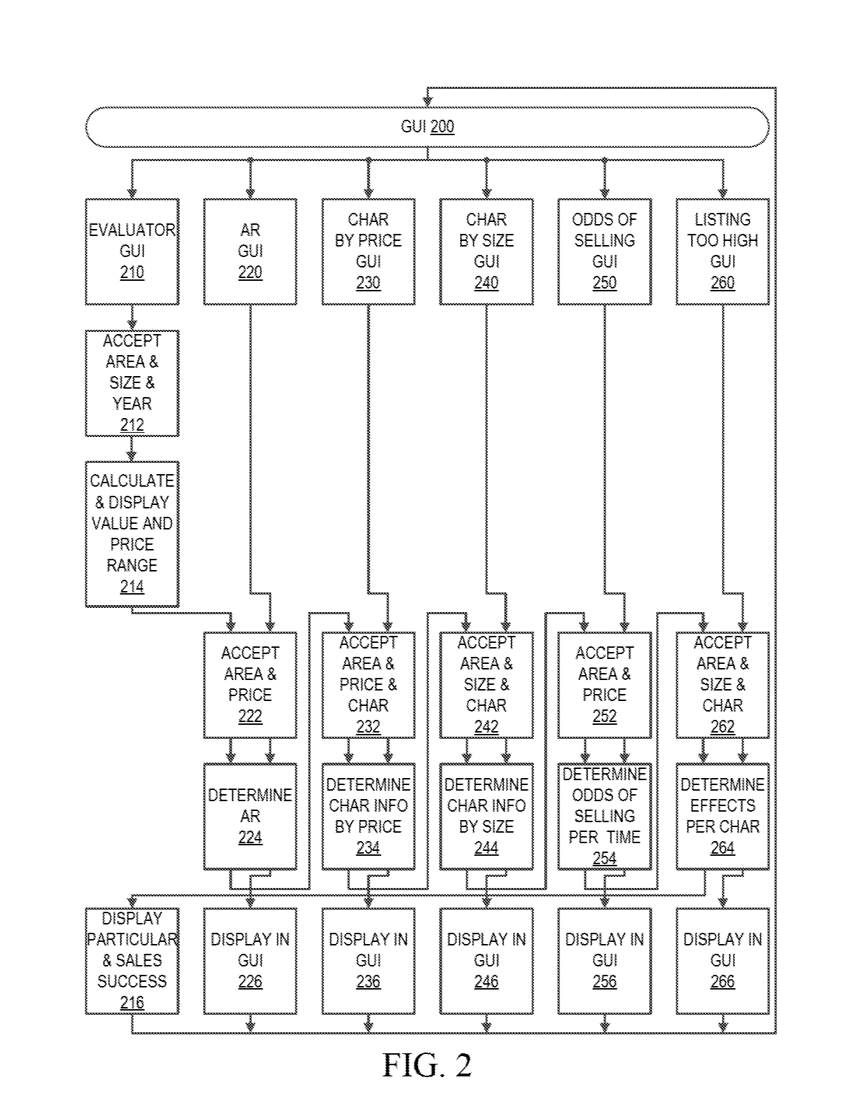

FIG. 2 shows how the applications 160 interact with the transacting user 195 through a graphical user interface (“GUI”) 200.

The GUI 200 includes various information display areas for communicating information to the users, as well as various user-operable virtual controls such as virtual buttons and selectors, including such selectors as pull-down lists, pop-up lists, and scrolling display areas. As the various types of selectors are generally interchangeable, reference herein to any particular type of selector is illustrative. Selectors may also display information, while information display areas may contain user-selectable links, virtual selectors, and such. Moreover, the selectors shown in the figures herein are merely indicative of a wide variety of virtual selection structures available for use in GUI's, and the shape of the selectors and information display areas shown in the figures are illustrative and may be varied if desired. Moreover, while the placement of the various selectors and information display areas shown in the figures is intended to be appealing and easily understandable to and usable by most users, it is illustrative and other placements may be used if desired. While the screen images illustrated in the figures are shown as a single page fully displayed, the page may be displayed less than fully but viewable in full by scrolling, or by displaying successive sections of the page in successive screens.

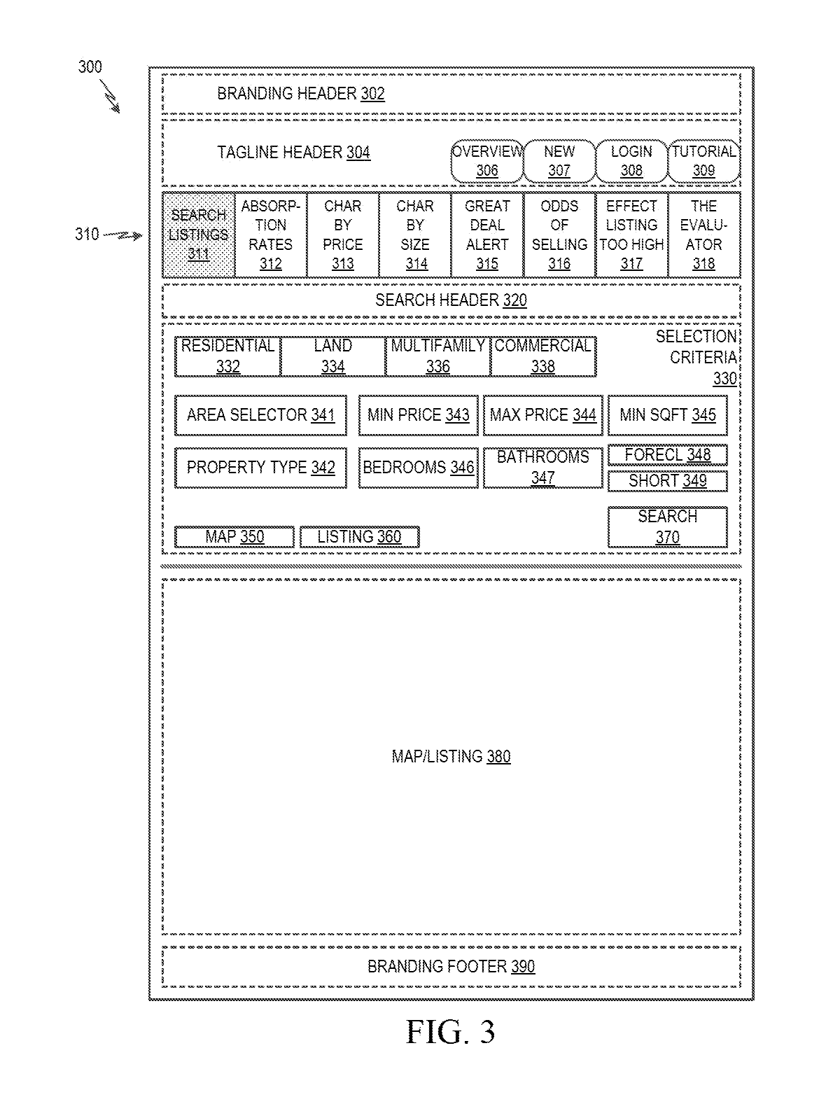

Common to many screens of the GUI 200 are the branding header 302, the branding footer 390, and a tagline header 304, as shown in a search listings screen 300 in FIG. 3. Illustratively, the branding header 302, the branding footer 390, and the tagline header 304 are essentially the same from screen to screen, although they may be different if desired.

The branding header 302 and the branding footer 390 may contain branding information for the particular real estate professional sponsoring the real estate interactive resource, and are helpful for lead generation since they provide continuous exposure of the real estate professionals to the transacting user 195. The branding header 302 and branding footer 390 may be the same or may be different. Illustrative branding information which may be included in the branding header 302, the branding footer 390, or in both includes name, corporate affiliation, website URL, email address, mobile number, text number, office number, postal address, professional organization affiliations, professional awards, and so forth. Pictures of the real estate professional, organization logos, links to audio or multimedia messages, and so forth may also be included.

The tagline header 304 contains a phrase or message associated with the interactive real estate information resource, and illustratively is juxtaposed with a virtual overview button 306 for invoking a description of the interactive real estate information resource, a virtual new user button 307 for registering as a new user which generates a lead for the real estate professional, a virtual login button 308 for returning registered users, and a virtual tutorial button 309 for tutoring a new transacting user in the use of the interactive real estate information resource. The tutorial may be in text, video, audio, multimedia, or other type of presentation, or a chat window or other type of real time or near real time communication with another person.

Also common to many screens of the GUI 200 is a set 310 of navigation buttons, for user navigating to a particular one of the applications 160. The set 310 of navigation buttons includes a “search” button 311, an “absorption rates” button 312, a “characteristic by price” button 313, a “characteristic by size” button 314, a “great deal alert” button 315, an “odds of selling” button 316, an “effect of listing too high” button 317, and an “evaluator” button 318.

As shown in FIG. 3, selecting the search listings button 311 causes a search listings screen 300 to be displayed by the GUI 200. The search listings screen 300 allows the transacting user 195 to interactively select a real estate type to search, illustratively residential property, land, multifamily property, or commercial property, or even any combination thereof, by selecting one or optionally more of respective virtual buttons 332, 334, 336 or 338. In addition, other characteristics of interest to the transacting user 195 such as the MLS geographical area, property type (such as, for example, site/stick built, shared ownership, manufactured/module, or condo/townhouse), minimum price, maximum price, minimum square foot, number of bedrooms, and number of bathrooms may be interactively selected (one or more of such characteristics may be unrestricted if desired) by operating respective selectors 341-347, which may be, for example, pull-down type selectors. Foreclosed and short sale properties may be included or excluded from the search by operating buttons 348 and 349, which may be, for example, checkbox type buttons. The search is executed by selecting the search button 370, and the results of the search may be displayed to the transacting user 195 in any suitable manner, illustratively in map or listing form as selected by the transacting user 195 by operating respective buttons 350 or 360, which may be, for example, radio buttons. The map or listing of the search results may be displayed in an area 380 of the search listings screen 300 or on a separate page, as desired.

The map or listing of the search results may be static or interactive, as desired. In one example of an interactive listing (not shown), each result is displayed with a picture, address, number of bedrooms, number of bathrooms, square footage, year built, geographical area, and price. User-selectable options may include a summary of the geographical area, and further details and analysis of the property. If “further details and analysis” is selected, additional information such as exterior construction, interior features, views, property description, additional images and videos, and a detailed map of the area may be provided. In addition, separate links to various buyer/seller tools available in the interactive real estate information resource system may be provided in narrative form for user convenience, such as, for example, a “Check out the market supply and demand” link which uses the absorption rates application 161, a “Compare to recent sales by price” link which uses the characteristics by price/size application 162, a “Compare to recent sales by size” link which uses the characteristics by price/size application 162, a “The Seller's odds of selling” link which uses the odds of selling application 164, an “Is it listed too high” link which uses the effect of listing too high application 165, and a “Get your own evaluation” link which uses the evaluator 166. If the particular property listed in a good deal, the listing may include a “Good Deal (see why)” link which explains why the selected listing is a good deal and uses the great deal alert application 163 to show all good deals within the selected criteria. A search modification area provided with a subset of the search criteria such as an area selector, property type, minimum price, maximum price, and an execute search button may be provided so that the transacting user 195 may easily and conveniently modify the search if desired.

The choices made by the transacting user 195 on the search listings screen 300 may but need not be applied to other screens of the GUI 200. Where the choices are applied, they may be interactively modified by the user on the other screens if desired. Should the transacting user 195 return to the search screen 300 after modifying other screens, the search parameters for the interactive real estate resource may be reset to the choices made on the search screen 300.

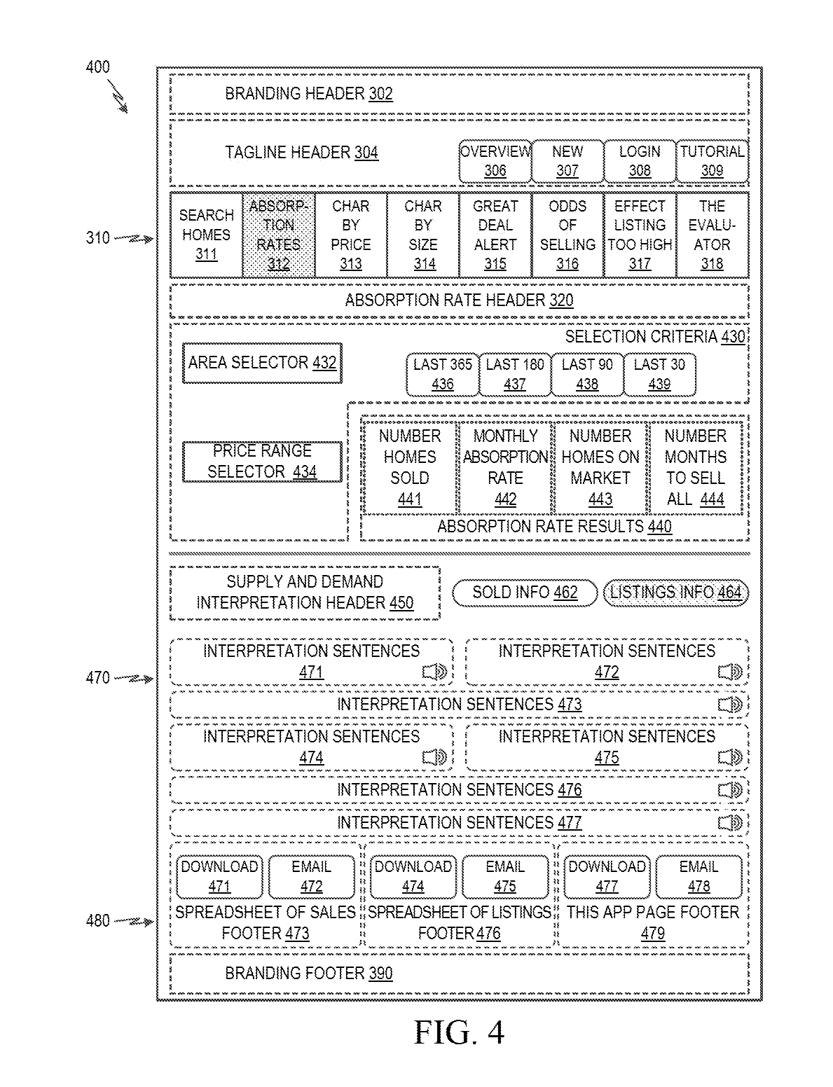

As shown in FIG. 4, selecting the “absorption rates” button 312 causes an absorption rate screen 400 to be displayed by the absorption rates application 161. The absorption rates application 161 informs a seller about market demand. It identifies a seller's competition, tracks the number of competitive sales a month and pinpoints how long it will take to sell the current inventory in a seller's price-range. It helps a seller with list price strategy. The absorption rates application 161 helps a buyer understand whether a market is to a buyers advantage or not, and it also becomes information that his helpful to offering price and strategy.

Illustratively, the absorption rate screen 400 includes an absorption rate header 320 which describes “absorption rate” in a general manner. A selection criteria area 430 is provided to allow the transacting user 195 to establish the search criteria. Illustratively, the selection criteria area 430 includes a pulldown area selector 432, a pulldown price range selector 434, and four “time period” buttons 436-439 for selecting a desired listing or sales period, illustratively the last 365 days, the last 180 days, the last 90 days, and the last 30 days respectively. The absorption rate screen 400 includes various areas for displaying absorption rate results 440 based on the selection criteria 430, illustratively an information display area 441 for displaying the number of homes sold, an information display area 442 for displaying the monthly absorption rate, an information display area 443 for displaying the number of homes on the market, and an information display area 444 for displaying the number of months to sell all homes. A selector (not shown) may be provided to display the sold properties or the listed properties in a suitable screen, such as a popup screen (not shown). The selection criteria 430 may be modified as desired by the transacting user 195 and the absorption rate results 440 are dynamically updated as appropriate for the new selection criteria.

A supply and demand interpretation area 470 includes a supply and demand interpretation header 450 which may describe absorption rate, what it means, why it is important, and what should be done with it. A variety of interpretation sentences 470 are provided to assist the user's understanding of the data. The interpretation sentences explain the absorption rate in a detailed but non-technical manner, and incorporate some or all of the selection criteria 430 and key absorption rate information so that the meaning and implications of this information may be conveyed to the user without needing to divert the user's attention to other areas of the absorption rate screen 400. The explanations may pertain to either sold properties or listed properties, depending on whether the sold information button 462 or the listings information button 464 is selected (buttons 462 and 464 may be radio buttons, for example). The text and background of the individual interpretation sentences 471-477 may be colored or shaded as desired to improve readability or convey a particular sense of importance or other function, as desired. The interpretation sentences 470 are context-sensitive and dynamic, with each user query invoking as many interpretation sentences as needed, illustratively from two to seven associated interpretation sentences. The display area for each of the interpretation sentences 471-477 may have any desired shape, including simple rectangle as shown in FIG. 4, text bubbles, and so forth. While shown arranged in a grid, the various interpretation sentences 470 may be arranged in any other manner that is pleasing and informative to the user, including vertically with or without indentation.

While the information populating the various information areas of the screen 400 depends on the user's choices and the data contained in the particular MLS database selected, the following are illustrative. Absorption rate header 320: “Absorption rates are the average number of homes sold per month. This specifically addresses market supply and demand.” Area Selector 432: “All SW Reno.” Price Range Selector 434: “$200,001-$250,000.” Last 365 day selector 436 selected. Number of Homes Sold 441: “92.” Monthly Absorption Rate: “7.7.” Number Homes on Market: “14.” Number Months to Sell All: “1.8.” Interpretation Sentences 471: “There are 14 All SW Reno real estate listings for sale in this price range right now. We call this the inventory.” Interpretation Sentence 472: “At the current monthly absorption rate of 7.7 home sales per month, it will take 1.8 months to sell this inventor in this price range.” Interpretation Sentence 473: “An inventory of more than 6 months is a buyer's market. Less than that is a seller's market.” Interpretation Sentence 474: “If you are a seller, this is your competition. Compare the listings here to your house. Would you buy it now instead of any other?” Interpretation Sentence 475: “If not, you may wish to put your house in a lower price range. It will save you much time and a lot of money if you do.” Interpretation Sentence 476: “The average time it takes to sell a home in All SW Reno over the last 365 days is 140.8 days (5 months).” Interpretation Sentence 477: “If you are researching this as a home seller, the consequences of listing your house too high are often serious. It will cost you significant time and much money. Please check the effects of listing too high for details.”

The absorption rate screen 400 as well as some other screens of the GUI 200 offer certain data, statistics and interpretation sentences to the transacting user 195, by any desired means. Illustratively, spreadsheet and/or PDF files are offered to the transacting user 195 via download or email in an information request area 480. Footer 473 offers a spreadsheet of sales per selected area and price range via download by button 471 or via email by button 472. Footer 476 offers a spreadsheet of listings per selected area and price range via download by button 474 or via email by button 475. In addition, footer 479 offers a PDF image of the absorption rates screen 400 via download by button 477 or via email by button 478. Buttons 471, 472, 474, 475, 477 and 478 are illustrative, and other types of buttons may be used if desired. While the transacting user 195 may request the spreadsheet and PDF files for his or her future reference without assistance of the real estate profession, the request may still serve as a lead generation tool for the real estate professional. If the absorption rate tool is being used by a real estate professional during a meeting with a client, these buttons enable the real estate professional to be immediately responsive to client requests for information.

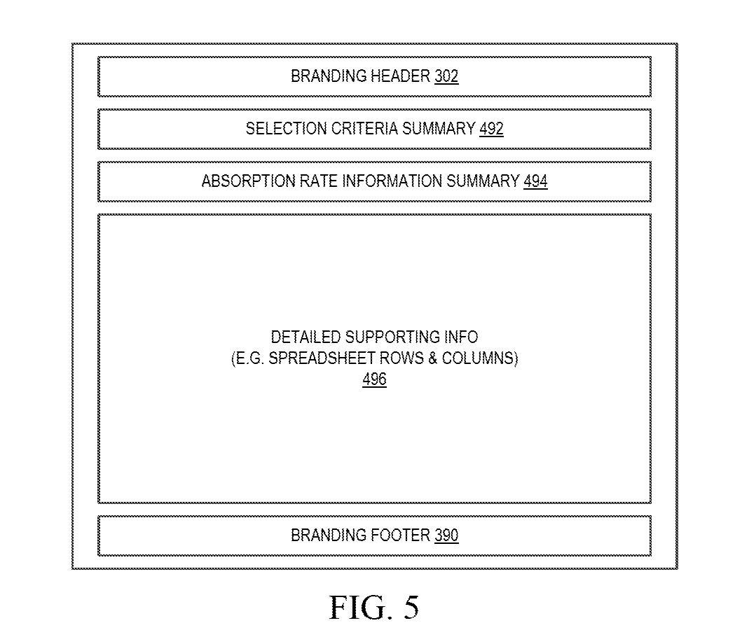

FIG. 5 shows an illustrative layout of a spreadsheet of either sales detail or listings details as may be downloaded or emailed via the information request area 480. The detailed information from which the absorption rate is calculated may be made available in the form of a spreadsheet 496 or other desired form, and may span multiple pages if necessary. Branding header 302, selection criteria summary area 492, absorption rate information summary area 494, and branding footer 390 may be repeated on multiple pages. The selection criteria summary area 492 displays the selection criteria selected by the user for the absorption rate study, illustratively the Area Selector 432 (“All SW Reno”) and the Price Range Selector 434 (“$200.001-$250,000”). The absorption rate information summary area 494 displays such information as total sales over the last 365 days, the average number of sales per month, and the number of properties for sale right now.

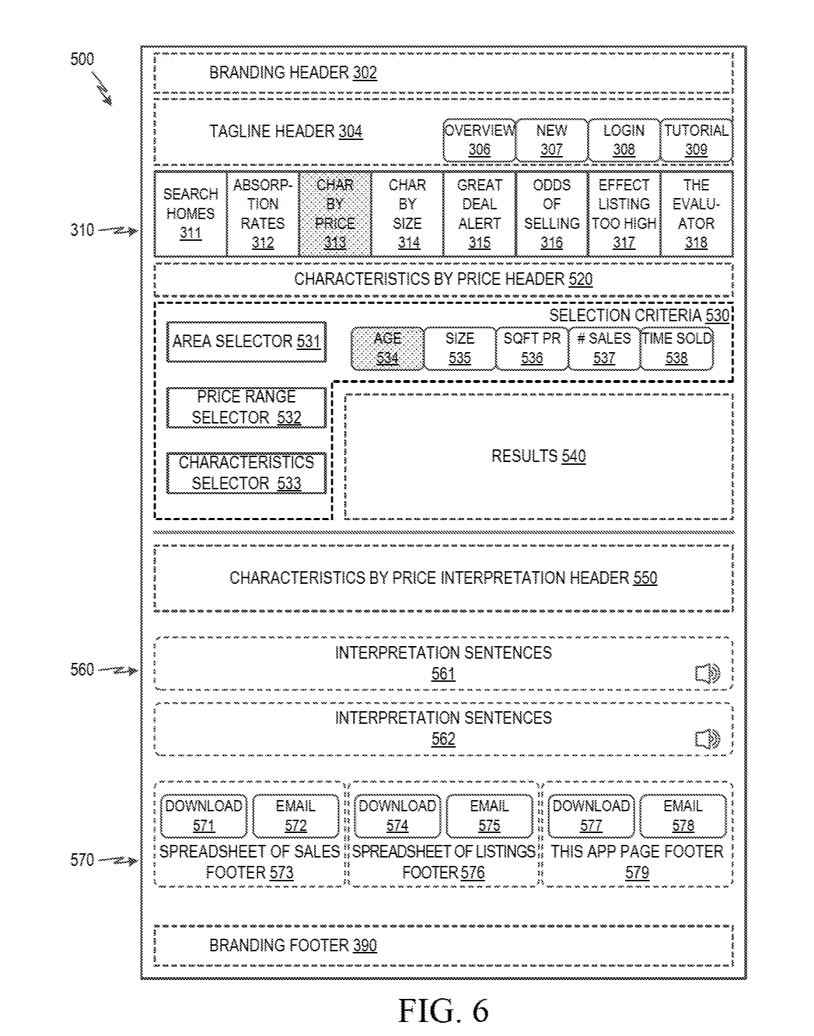

FIG. 6 shows a characteristics by price screen 500. Selecting the “characteristics by price” button 313 causes the characteristics by price screen 500 to be displayed by the characteristic by price/size application 162. The characteristics by price/size application 162 informs a seller about current home prices by examining the key characteristics of a house over time, and allows a buyer or seller to compare a house in a price range in today's market to all other sales in preceding years. The key characteristics displayed are size of house, age of house, time on market, square foot value, and number of homes sold.

A selection criteria area 530 appears which contains a pulldown area selector 531, a pulldown price range selector 532, and a pulldown characteristic selector 533. The options available with the characteristic selector 533 may be quite comprehensive, and include, for example, the average age in years, the oldest, or the newest; the average size in square feet, the smallest, or the largest; the average price per square foot, the least, or the most; the total number of sales for all properties, for bank owned (real estate owned or “REO”), for short sales, total distressed sales, or percentage distressed sales; and the average time to sell (days on market or “DOM”), the least, or the most. Additional buttons 534-538 may be provided for quickly and conveniently selecting common characteristics such as, respectively, the average age in years, the average size in square feet, the average price per square foot, the total number of sales, and the average time to sell.

The characteristics by price header 520 may include a title which not only contains the selected area and price range, but also the name of the specific characteristics selected. A results display area 540 displays the results of the user's query in any desired form, illustratively as a bar graph.

Upon selection of an area, a price range, and a characteristic using the area selector 531, the price range selector 532, and the characteristics selector 533 or one of the characteristics buttons 534-538, illustratively age button 441, the results display area 540 is populated with illustratively a bar graph showing the average ages of homes sold over a period of time, illustratively over the last nine years, along with the average ages of homes sold over the last 365 days and the average ages of homes sold over the last 180 days. The results display area 540 may dynamically change as different characteristics are selected.

A variety of interpretation sentences 560 are provided to assist the user's understanding of the data. The interpretation sentences 560 explain the characteristics by price results 540 in a detailed but non-technical manner, and may incorporate some or all of the selection criteria 530 and data underlying the results 540 so that the meaning and implications of this information may be conveyed to the user without needing to divert the user's attention to other areas of the screen 500. The text and background of the individual interpretation sentences 561 and 562 may be colored or shaded as desired to improve readability or convey a particular sense of importance or other function, as desired. The interpretation sentences 560 are context-sensitive and dynamic, with each user query invoking as many interpretation sentences as needed, illustratively from two to seven associated interpretation sentences. The display area for each of the interpretation sentences 561 and 562 may have any desired shape, including simple rectangle as shown in FIG. 6, text bubbles, and so forth. While shown arranged in a row, the various interpretation sentences 561 and 562 may be arranged in any other manner that is pleasing and informative to the user, including vertically with or without indentation.

While the information populating the various information areas of the characteristics by price screen 500 depends on the user's choices and the data contained in the particular NLS database selected, the following are illustrative. Characteristics by Price Header 520: “Characteristics by Price helps a home buyer identify the deal they are looking for . . . and helps make sure they are not paying too much. It helps Sellers better understand the right list price.” Area Selector 531: “All SW Reno.” Price Range Selector 532: “$200.001-$250,000.” Characteristics by Price Interpretation Header 550: link to “What it is, what it means, why it's important and what you should do about it.” Interpretation Sentences 561: “In the last 365 days (1 year in the chart), the All SW Reno house in this price range is 4 years OLDER than it was in 2012 (last year). It is 35 years NEWER than sales in this price range in 2007.” Interpretation Sentence 562: “An older house is usually less costly for a home buyer. “Less costly” is often a key characteristic of the deal you are looking for.”

Illustratively, spreadsheet and/or PDF files are offered to the transacting user 195 via download or email in an information request area 570. The information request area 570 is similar to the information request area 480 (FIG. 4), with the spreadsheets of sales and listings being for the selected area and price range.

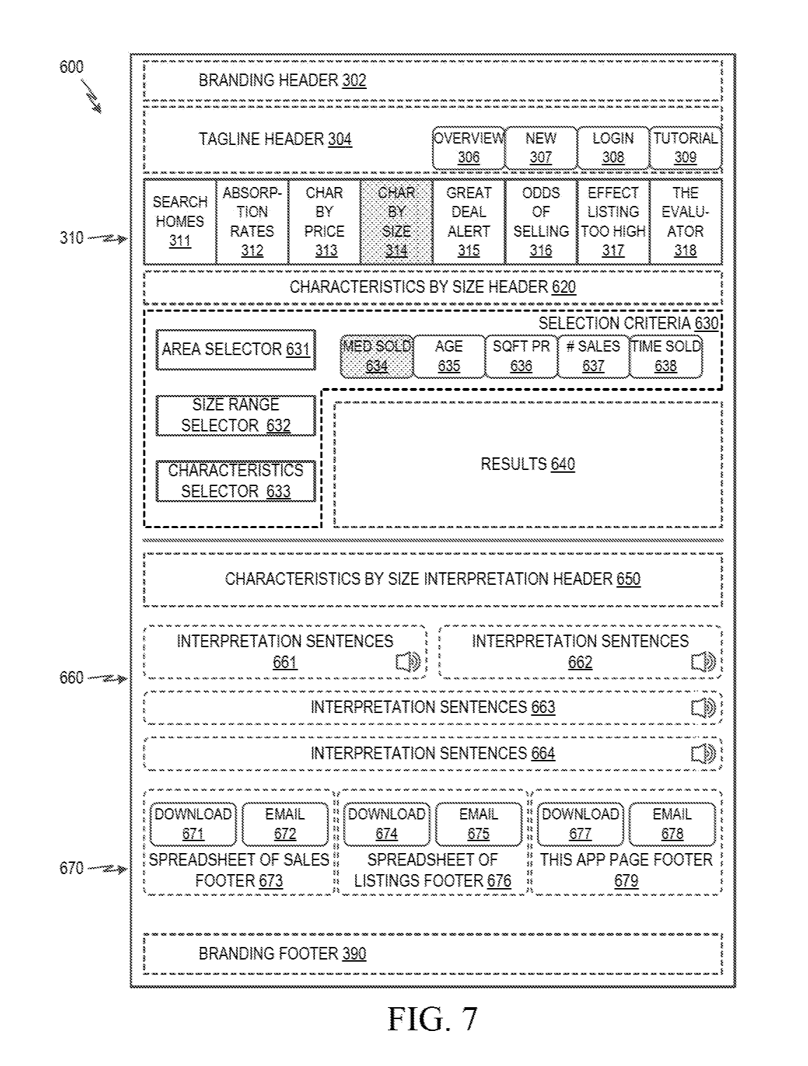

FIG. 7 shows a characteristics by size screen 600. Selecting the “characteristics by size” button 314 causes the characteristics by size screen 600 to be displayed by the characteristic by price/size application 162. The characteristics by price/size application 162 helps a seller develop a listing strategy by examining key characteristics of a house based on comparative size over time. This gives a seller a graphic and narrative analysis what his house is worth right now based on all recent relevant homes sold. The characteristics by price/size application 162 also helps a buyer investigate the listing price of a house he finds of interest against recent sales, thereby fundamentally helping a buyer understand, and gain comfort that the buyer is not paying too much.

A selection criteria area 630 appears which contains a pulldown area selector 631, a pulldown size range selector 632, and a pulldown characteristic selector 633. The options available with the characteristic selector 633 may be quite comprehensive, and include, for example, the median sold price, the average list price, the percentage reduction, the low sale, or the high sale; the average age in years, the oldest, the newest, or the average year built; the average price per square foot, the least, or the most; the average time to sell (days on market or “DOM”), the least, or the most; and the total number of sales for all properties, for bank owned (real estate owned or “REO”), for short sales, total distressed sales, or percentage distressed sales. Additional buttons 634-638 may be provided for quickly and conveniently selecting common characteristics such as, respectively, the median sold price, the average age in years, the average price per square foot, the total number of sales, and the average time to sell. The characteristics by size header 620 may include a title which not only contains the selected area and size range, but also the name of the specific characteristics selected. A results display area 640 displays the results of the user's query in any desired form, illustratively as a bar graph.

Upon selection of an area, a size range, and a characteristic using the area selector 631, the size range selector 632, and the characteristics selector 633 or one of the characteristics buttons 634-638, illustratively median sold price button 634, the results display area 640 is populated with illustratively a bar graph showing the median sold price of homes sold over various periods of time, illustratively the last year, the last six months, since 2012, since 2011, since 2010, since 2009, since 2008, since 2007 and since 2006. The results display area 640 may dynamically change as different characteristics are selected.

A variety of interpretation sentences 660 are provided to assist the user's understanding of the data. The interpretation sentences 660 explain the characteristics by size results 640 in a detailed but non-technical manner, and may incorporate some or all of the selection criteria 630 and data underlying the results 640 so that the meaning and implications of this information may be conveyed to the user without needing to divert the user's attention to other areas of the screen 600. The text and background of the individual interpretation sentences 661-664 may be colored or shaded as desired to improve readability or convey a particular sense of importance or other function, as desired. The interpretation sentences 660 are context-sensitive and dynamic, with each user query invoking as many interpretation sentences as needed, illustratively from two to seven associated interpretation sentences. The display area for each of the interpretation sentences 661-664 may have any desired shape, including simple rectangle as shown in FIG. 7, text bubbles, and so forth. While shown arranged adjacent and in rows, the various interpretation sentences 661-664 may be arranged in any other manner that is pleasing and informative to the user, including vertically with or without indentation.

While the information populating the various information areas of the characteristics by size screen 600 depends on the user's choices and the data contained in the particular MLS database selected, the following are illustrative. Characteristics by Size Header 620: “Characteristics by Size helps a home seller better understand value, and how to best develop a successful listing for sale strategy. It also helps buyers check values of home of interest.” Size Range Selector 632: “1,500 Sq Ft.” Characteristics by Size Interpretation Header 650: link to “What it is, what it means, why it's important and what you should do about it.” Interpretation Sentences 661: “In the last 365 days (1 year in the chart), the median sold price in All SW Reno in this size range is $5000 LOWER that it was in 2012 (last year).” Interpretation Sentence 662: “A HIGHER median sold price trend suggests that the value of the home a BUYER buys today will increase over time.” Interpretation Sentence 663: “A HIGHER median price trend spread over years indicates that today's home buyer is likely making a sound investment.” Interpretation Sentence 664: “A HIGHER median sold price trend is a SELLER'S advantage. (Check ‘The Effect of Listing Too High’ to best understand.)”

Illustratively, spreadsheet and/or PDF files are offered to the transacting user 195 via download or email in an information request area 670. The information request area 670 is similar to the information request area 480 (FIG. 4), with the spreadsheets of sales and listings being for the selected area and size range.

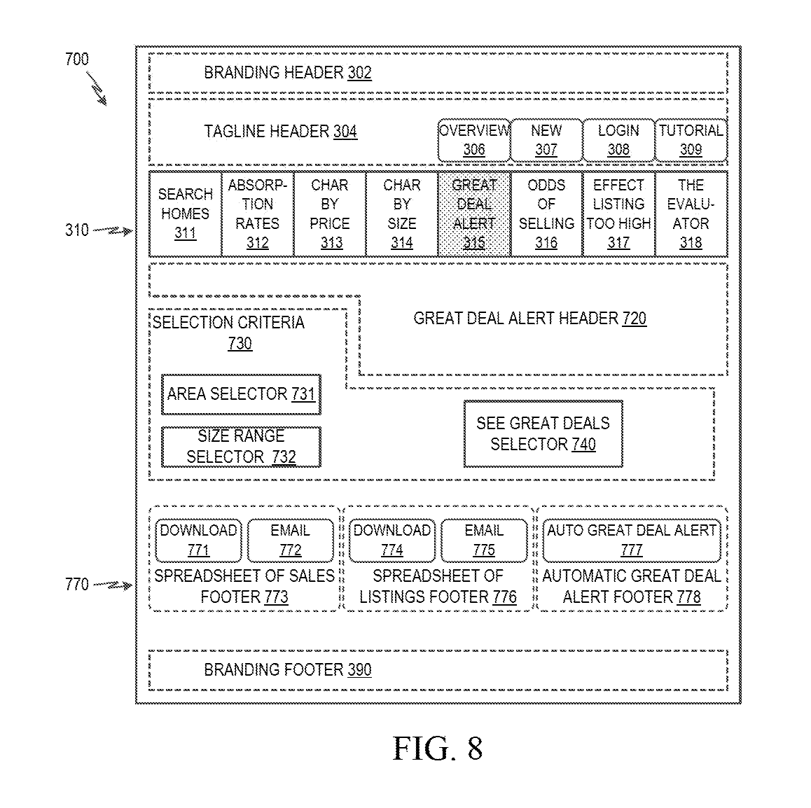

FIG. 8 shows a great deal alert screen 700. Selecting the “great deal alert” button 315 causes the great deal alert screen 700 to be displayed by the great deal alert application 163. The great deal alert application 163 instantly informs the transacting user 195 of properties based on the user's selection criteria, and are exceptional in some respect, illustratively by being priced under the median sold price, by being larger than the average square footage, by being newer than the average year built, or a combination thereof.

A great deal alert header 720 may include a title and a general description of how the great deal alert results, including various deal “categories,” may be useful. If desired, the great deal alert header 720 may also include a summary of the selected area and size range. Illustratively, the great deal categories may be “Good Deal” which is exceptional in one of the three ways, “Great Deal” which is exceptional in two of the three ways, and “Spectacular Deal” which is exceptional in all three ways. A selection criteria area 730 contains a pulldown area selector 731, a pulldown size range selector 732, and a selector 740 for providing the great deal alert results.

Illustratively, spreadsheet and/or PDF files are offered to the transacting user 195 via download or email in an information request area 770. The information request area 770 is similar to the information request area 480 (FIG. 4), with the spreadsheets of sales and listings being for the selected area and size range. However, instead of offering a PDF copy of the great deal alert screen 700, selector 777 offers to automatically email every new great deal matching the user's selection criteria to the transacting user 195, as stated in the automatic great deal alert footer 778.

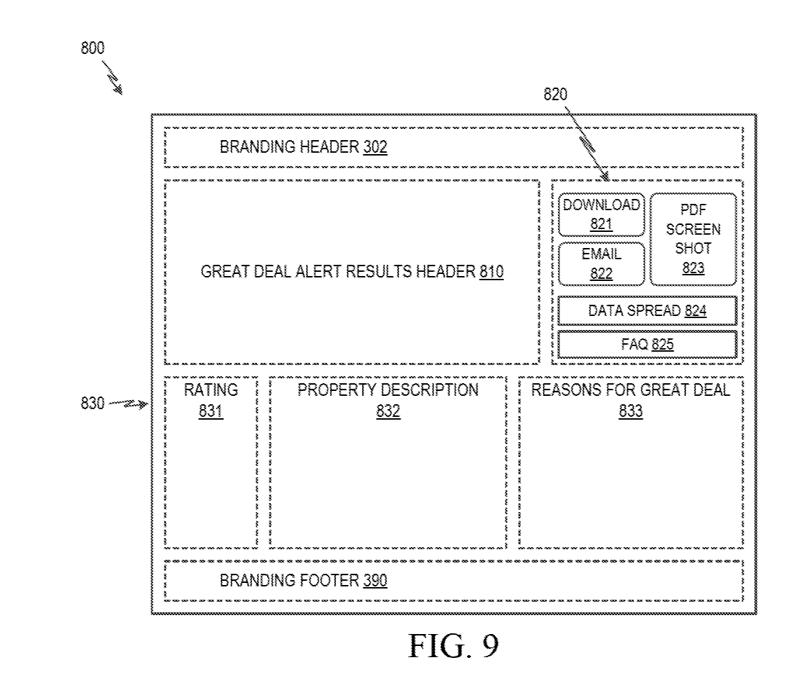

While a results display area may be provided in the great deal alert screen 700 for displaying results, illustratively results may be displayed on a separate great deal alert results screen 800 as shown in FIG. 9. A great deal alert results header 810 may include a title and a description which may contain a summary of the selected area and size range, illustratively “Based on market activity in the last 180 days and current listings in All SW Reno in the 1,500 Sq Ft range.” The results may be provided in any desired form, such as a map or a listing. In one example of an interactive listing, each result is displayed with a rating 831 (Good Deal, Great Deal, Spectacular Deal), a property description 832 which may include a picture, address, number of bedrooms, number of bathrooms, square footage, year built, and price. User-selectable options may include a selector to access further details about the property, such as, for example, exterior construction, interior features, views, property description, additional images and videos, and a detailed map of the area may be provided. The further details may be provided in any desired manner, such as part of the great deal alert results screen 800, as a popup window, or as a separate screen. A reason for the great deal area 833 may be provided to explain the reason for the rating 831; illustratively, “It Costs Less! List price is below median sold price.”

The information request area 820 includes five selectors. Illustratively, selectors 821 and 822, illustratively virtual buttons are for the transacting user 195 to request files of the deal alert results via download or email. Illustratively, selector 823, illustratively a virtual button, is for the transacting user 195 to request a PDF screen shot of the deal alert results. Illustratively, selectors 824 and 825, illustratively hyperlinked text, are for the transacting user 195 to request a data spread of the deal alert results or to consult the frequently asked questions regarding great deals. A data spread provides various information regarding the spread of the data for the selected area and square foot size, illustratively the median sold price, list versus sold price difference as a percentage, the average size, the average year built, the biggest size within a range accorded to the square foot size criteria, the smallest size within a range accorded to the square foot size criteria, the year built for the newest property, the year built for the oldest property, the current low list price, and the current high list price. The data spread and the FAQ may be provided in any desired manner, such as part of the great deal alert results screen 800, as a popup window, or as a separate screen.

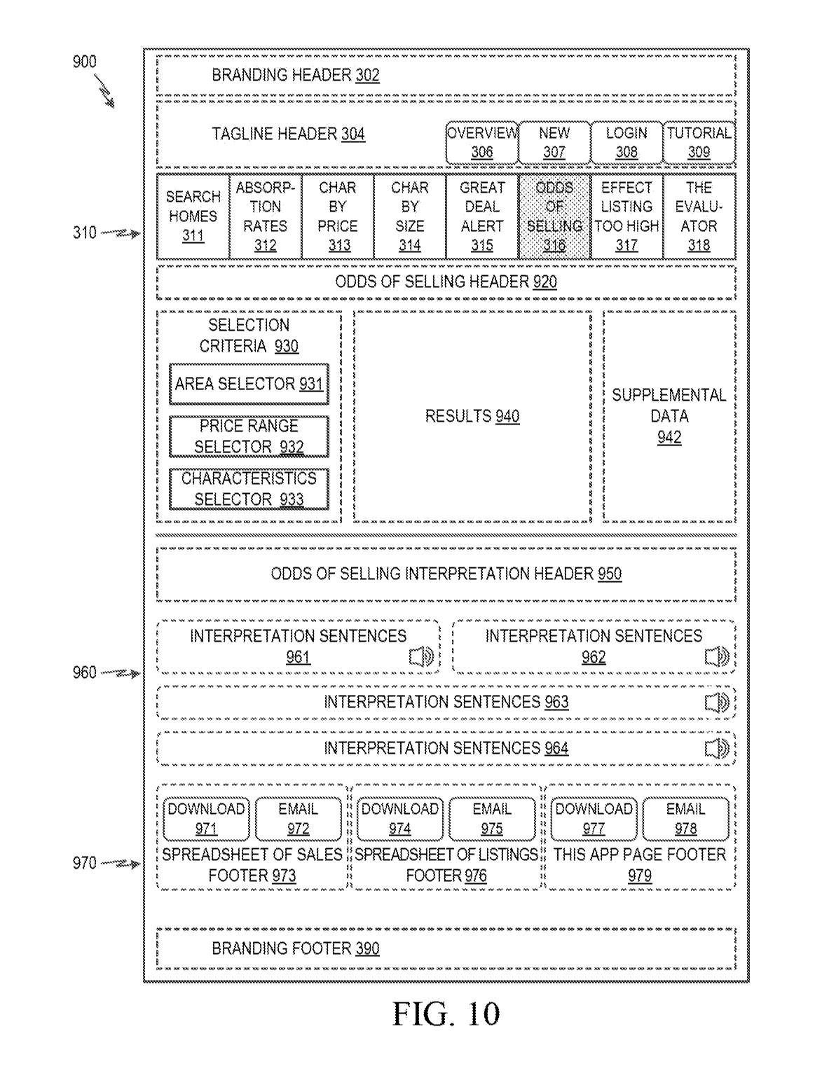

FIG. 10 shows an odds of selling screen 900. Selecting the “odds of selling” button 316 causes the odds of selling screen 900 to be displayed by the odds of selling application 164. The odds of selling application 164 helps a seller fully understand his or her odds of achieving success over time. This reviews the odds of selling within several, illustratively four, different time frames, and helps a seller gain an understanding that adjustments can be made to increase the odds of selling. Contributing information to help a seller make adjustments to increase the odds of selling is available from other applications within the applications level 160.

The odds of selling header 920 on the odds of selling screen 900 may include a title and a general description of how the odds of selling results may be useful. If desired, the odds of selling header 920 may also include a summary of the selected area and size range. A selection criteria area 930 contains a pulldown area selector 931, a pulldown price range selector 932, and a pulldown characteristic selector 933. The characteristics selector 933 selects from such criteria as sell in 1 year, sell in 6 months, sell in 90 days, sell in price range, and number of homes sold. A results area 940 displays the odds of selling based on the selection criteria in any desired manner, illustratively graphically by percentage. A bar graph showing the odds of selling in 1 year as 57% and the odds of not selling in one year as 43% is illustrative. A supplemental data area 942 displays supplemental information, such as, for example, such underlying numerical information as the number of homes listed in the selected price range of 101, and the number of houses sold in this price range of 47, for the one year period. The results area 940 and the supplemental data area 942 dynamically change as different characteristics are selected by the transacting user 195.

A variety of interpretation sentences 960 are provided to assist the user's understanding of the odds of selling. The interpretation sentences 960 explain the results 940 in a detailed but non-technical manner, and may incorporate some or all of the selection criteria 930 and data underlying the results 940 so that the meaning and implications of this information may be conveyed to the user without needing to divert the user's attention to other areas of the odds of selling screen 900. The text and background of the individual interpretation sentences 961-964 may be colored or shaded as desired to improve readability or convey a particular sense of importance or other function, as desired. The interpretation sentences 960 may be context-sensitive and dynamic, with each user query invoking as many interpretation sentences as needed, illustratively from two to seven associated interpretation sentences. The display area for each of the interpretation sentences 961-964 may have any desired shape, including simple rectangle as shown in FIG. 10, text bubbles, and so forth. While shown arranged in a grid, the various interpretation sentences 661-664 may be arranged in any other manner that is pleasing and informative to the user, including vertically with or without indentation.

While the information populating the various information areas of the screen 900 depends on the user's choices and the data contained in the particular MLS database selected, the following are illustrative. Odds of Selling Header 920: “Odds of Selling the All SW Reno House (from $200,001-$250,000 since 2006): Odds of Selling helps a home seller understand potential for sales success over time and increase their odds of selling for MORE . . . quicker!” Area Selector 931: “All SW Reno.” Price Range Selector 932: “$200,001-$250,000.” Characteristics Selector 933: “Sell in 1 year.” Interpretation Sentences 961: “There is a 57% chance of selling a house listed in All SW Reno in this price range in one year.” Interpretation Sentence 962: “There is a 43% chance of a house listed in this price range NOT SELLING within one year.” Interpretation Sentence 963: “With the exception of luxury homes, almost all homes that take more than 90 days to sell are listed too high.” Interpretation Sentence 964: “Call me at (123) 456-7890 or email me at abc@def.com and I will help you immediately to increase your odds of selling.”

Illustratively, spreadsheet and/or PDF files are offered to the transacting user 195 via download or email in an information request area 970. The information request area 970 is similar to the information request area 480 (FIG. 4), with the spreadsheets of sales and listings being for the selected area and price range.

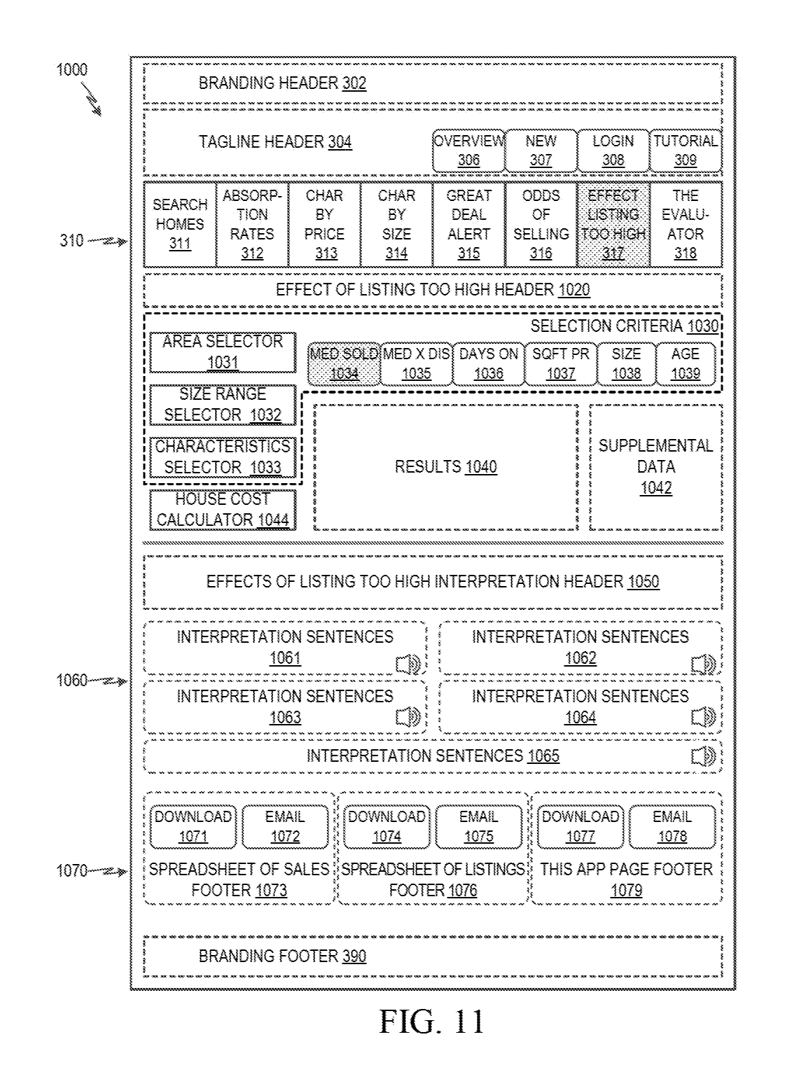

FIG. 11 shows an effect of listing too high screen 1000. Selecting the “effect of listing too high” button 317 causes an effect of listing too high screen 1000 to be displayed by the effect of listing too high application 165. The effect of listing too high application 165 identifies what it costs a home seller to list their house too high, both in terms of time and money. The information provided gives a seller precise information to gain an understanding that listing a house properly within current market conditions actually produces a higher sale—it identifies how much—than listing a house beyond current reason. When how much more time it takes to sell a house that is listed too high is added into the mix, a home seller has a clear picture to best make a listing price decision.

The effect of listing too high screen 1000 includes an effect of listing too high header 1020 which may include a title and a general description of how the effect of listing too high results may be useful. If desired, the effect of listing too high header 1020 may also include a summary of the selected area and size range. A selection criteria area 1030 contains a pulldown area selector 1031, a pulldown size range selector 1032, and a pulldown characteristic selector 1033. The options available with the characteristic selector 1033 may be quite comprehensive, and include, for example, the median sold price, the median sold price of distressed properties, the days on market, the days on market for distressed properties, the average list price, the average sold price per square foot, the average listed price per square foot, the average size, the average year built, the average number of bedrooms the percent of distressed properties, and the total properties sold. Additional buttons 1034-1039 may be provided for quickly and conveniently selecting common characteristics such as, respectively, the median sold price, the median sold price of distressed properties, the days on market, the average sold price per square foot, the average size, and the average year built (age). A results area 1040 displays in any desired manner the effect of listing too high results based on the selection criteria. A bar graph showing the median sold price for sales in less than 90 days and for sales in 180 days or more is illustrative. A supplemental data area 1042 displays supplemental information, such as, for example, observations on the bar graphs displayed in the results area 1040. The results area 1040 and the supplemental data area 1042 dynamically change as different characteristics are selected by the transacting user 195.

In one illustrative implementation, upon selection of an area and a size range using the area selector 1031 and the price range selector 1032, and selection of the desired characteristic using one of the buttons 1034-1039, illustratively the median sold price button 1034, the results area 1040 is populated with illustratively a bar graph showing, for example, the effect of listing too high expressed in terms of the median sold price of $185,000 for homes sold in less than 90 days in one bar, and the median price of $168,000 for homes sold in 180 days or more in another bar. Since the purpose of the bar graph is to show the uniqueness of what sells quickly and what does not sell quickly, the middle range of homes sold need not be presented, but may be presented if desired. The results area 1040 and the supplemental data area 1042 may dynamically change as different characteristics are selected with the selectors 1031-1039.

A variety of interpretation sentences 1060 are provided to assist the user's understanding of the effect of listing too high. The interpretation sentences 1060 explain the effect listing too high results 1040 in a detailed but non-technical manner, and may incorporate some or all of the selection criteria 1030, and data underlying the results 1040 so that the meaning and implications of this information may be conveyed to the user without needing to divert the user's attention to other areas of the screen 1000. The text and background of the individual interpretation sentences 1061-1065 may be colored or shaded as desired to improve readability or convey a particular sense of importance or other function, as desired. The interpretation sentences 1060 may be context-sensitive and dynamic, with each user query invoking as many interpretation sentences as needed, illustratively from two to seven associated interpretation sentences. The display area for each of the interpretation sentences 1061-1065 may have any desired shape, including simple rectangle as shown in FIG. 11, text bubbles, and so forth. While shown arranged in a matrix, the various interpretation sentences 1061-1065 may be arranged in any other manner that is pleasing and informative to the user, including vertically with or without indentation.

While the information populating the various information areas of the screen 1000 depends on the user's choices and the data contained in the particular MLS database selected, the following are illustrative. The results area 1040 is populated with illustratively a bar graph showing, for example, the effect of listing too high expressed in terms of median sold price of $185,000 for homes sold in less than 90 days in one bar, and $168,000 for homes sold in 180 days or more in another bar. The supplemental data area 1042 may be populated with the message “$17,000 MORE if you don't list too high, 217 more days to sell is 7.2 months, see what 7.2 months of your house costs actually are.” Effect Listing Too High Header 1120: “The Effect of Listing too high: All SW Reno 1,500 Sq Ft Size Range (1275 Sq Ft to 1725 Sq Ft): The Effect of Listing Too High gives a home seller the exact cost of listing a house too high in terms of time and money. (think hundreds of days and thousands of dollars!).” Area Selector 1031: “All SW Reno.” Size Range Selector 1032: “1,500 Sq Ft.” Characteristics Selector 1033: “Median Sold Price.” Interpretation Sentences 1061: “The All SW Reno house that is listed more reasonably sells QUICKER . . . and sells for an average of $17,000 MORE than houses that are listed too high.” Interpretation Sentence 1062: “Distressed properties (bank owned homes and short sales) ARE included in this chart.” Interpretation Sentence 1063: “What this means is listing too high COSTS a seller money in this size-range in All SW Reno. It also costs time.” Interpretation Sentences 1064: “If saving time, and an average of $17,000 is important to your selling strategy, you cannot list your house too high.” Interpretation Sentences 1065: “In other size and price ranges, the house that sold quicker could sell for LESS, but in this market. Please check “Med×Dist” above that does not include distressed properties. A different result is likely. It could be a lot MORE!”

The following are illustrative of the user's selecting the characteristic of Days on Market 1037 (not shown). The results area 1040 is populated with illustratively a bar graph showing, for example, the effect of listing too high expressed in terms of days on market of 50 days for homes sold in less than 90 days in one bar, and 267 days for homes sold in 180 days or more in another bar. The supplemental data area 1042 may be populated with the message “$17,000 MORE if you don't list too high, 217 more days to sell is 7.2 months, see what 7.2 months of your house costs actually are.” Area Selector 1031: “All SW Reno.” Size Range Selector 1032: “1,500 Sq Ft.” Characteristics Selector 1033: “Days on Market.” New Interpretation Sentences 1061: “All SW Reno houses listed lower in this size range . . . sell an average of 217 days quicker 97 months) . . . and sell for $17,000 MORE.” New Interpretation Sentences 1062: “If saving 217 days, and $17,000 is important to your selling decision, you cannot list your house too high.” New Interpretation Sentences 1063 and 1064 are omitted. New Interpretation Sentence 1065: “Distressed properties (bank owned homes and short sales) are included in this chart. Please check out the chart that does not include distressed properties. A different result is likely.”

Illustratively, spreadsheet and/or PDF files are offered to the transacting user 195 via download or email in an information request area 1070. The information request area 1070 is similar to the information request area 480 (FIG. 4), with the spreadsheets of sales and listings being for the selected area and size range.

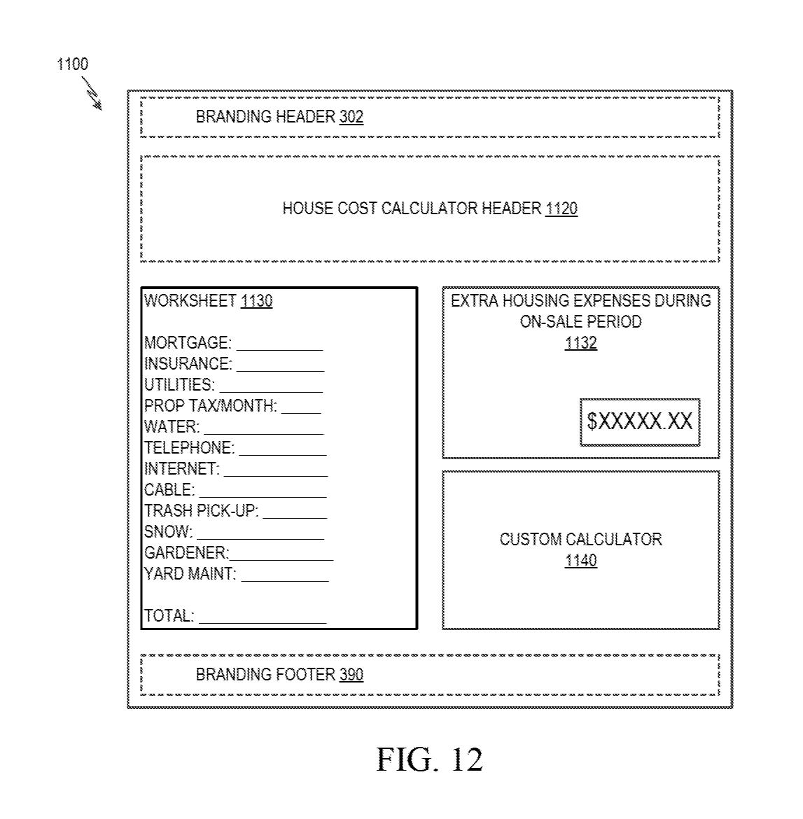

The effect of listing too high includes a number of other expenses that are not ascertainable from the MLS data. The effect of listing too high screen 1000 includes a button 180 to invoke the house cost calculator application 167 to take into account these other expenses. FIG. 12 shows an illustrative house cost calculator screen 1100 as may be generated by the house cost calculator application 167. The house cost calculator application 167 may be invoked in any desired manner, although a button or link from a GUI is particularly convenient. The house cost calculator may be displayed in any desired manner, although displayed as a pop up is particularly convenient. The house cost calculator application 167 may also be invoked from other screens and by other applications, as desired.

The house cost calculator screen 1100 includes a house cost calculator header 1120 which may include a title and a general description of how the house cost calculator may be useful. An illustratively house cost calculator header is as follows: “House Cost Calculator. We're happy to provide this handy tool to help you calculate house expenses. Remember to consider all house expenses per month over how long you think it will take to sell your house. A house that is listed too high normally takes 6 to 8 months longer to sell (or six to eight more months of your house expenses).”

The house cost calculator screen 1100 also includes a worksheet area 1130 which guides the user through entry of appropriate information for the house cost calculation. Appropriate information includes mortgage, insurance, utilities, property tax, water, telephone, the internet, cable, trash pick-up, snow removal, gardener and yard maintenance. The house cost calculator application 167 automatically calculates the total of such expenses, displays the total at the bottom of the worksheet area 1130, and displays the product of the total and the number of days on market in an “extra housing expenses during on-sale period” area 1132. The extra housing expenses area 1132 may also display particular selection criteria 1030 (FIG. 11) such as area and size range. Illustratively, the extra housing expenses area 1132 may display the following message, based on a monthly total house expenses of $2,235: “What It Means. Extra house costs to list a All SW Reno house too high between 1275 and 1725 sq ft. Listing a ALL SW Reno house too high causes an average 217 days or 7.2 months MORE to sell, which is $16.166 of extra house costs. Do you want to lose this much time and money?” If the transacting user 195 wishes to prepare his or her own estimate, the house cost calculator screen 1100 may include a custom calculator area 1140, wherein the transacting user may enter his or her own estimate of monthly expenses and the number of on-sale months, from which the product is calculated and displayed.

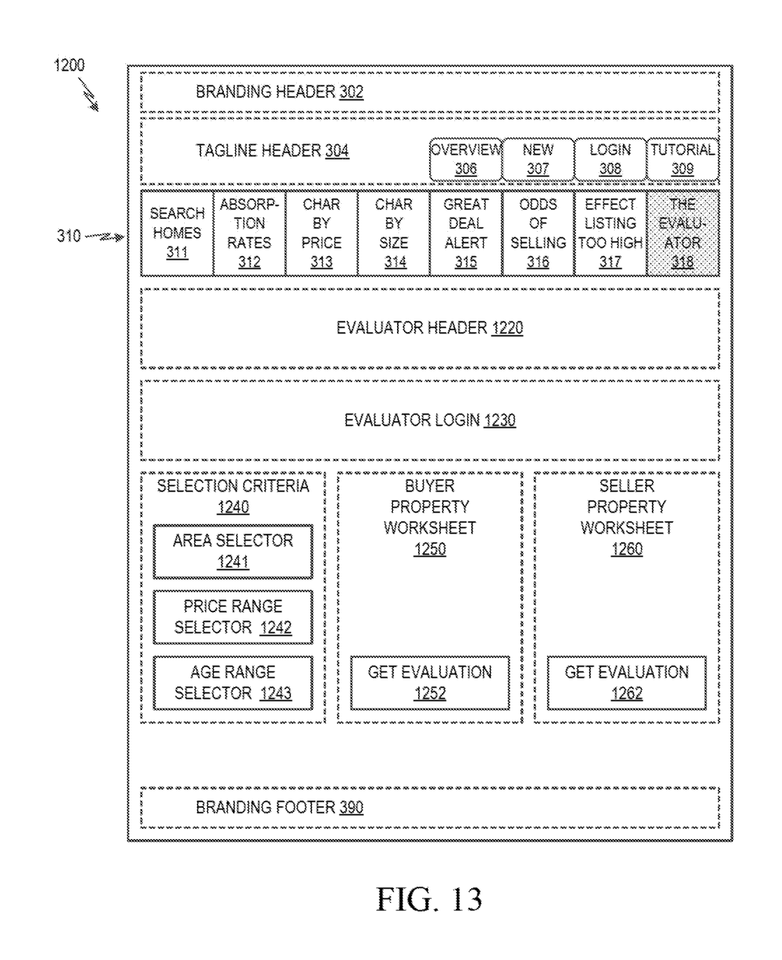

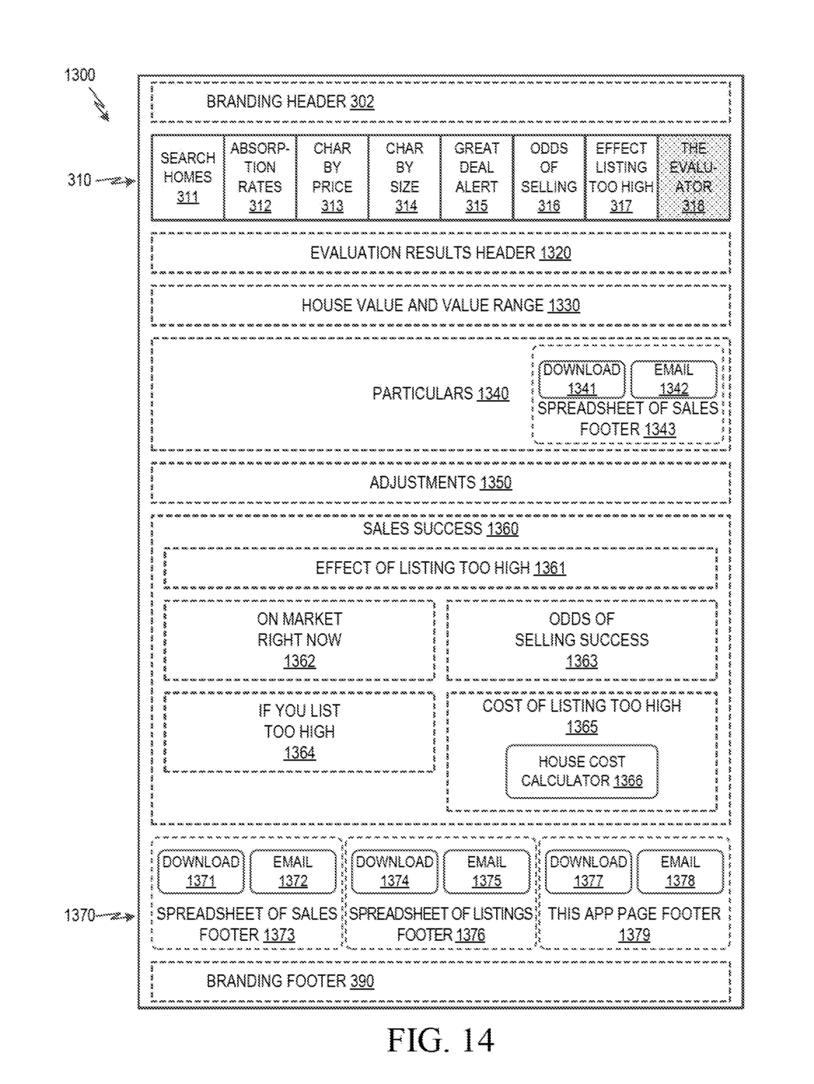

FIG. 13 shows an evaluator query screen 1200 and FIG. 14 shows an evaluator results screen 1300. Selection of the evaluator button 318 invokes the evaluator application 166, which produces a house value and an estimated sales range based on a specified area, size or size range, and age or age range as specified by the user. Where the user is a seller, the evaluator application 166 suggests a realistic selling price and provides related information so that the seller can appreciate that he or she is getting the most possible money from the sale. Where the user is a buyer, the evaluator 166 suggests a realistic buying price and provides related information so that the buyer can be comfortable that the house is priced right and that he or she is not paying too much.

Although the evaluator application 166 may be made available without an account, it is most effective to the transacting user 195 when the transacting user 195 establishes an account. An account enables the transacting user 195 to easily and conveniently save and review queries and results from one session to the next, and to compare results for the same type of property over a period of time, which facilitates the user's property investigations over multiple sessions. An account which requires the transacting user 195 to provide his or her name and contact information also serves a lead capture function, which benefits the real estate professional.

The evaluator query screen 1300 includes an evaluator header 1220 which provides a title and general description of how the evaluator may be useful. Illustratively, the evaluator header 1220 may contain the following description for a seller: “Find your realistic Selling Price! This is for Sellers who are thinking of selling . . . who want to get the most possible, which requires a realistic selling price (check the “Effect of Listing too High” to best appreciate why).” The evaluator header 1220 may also contain the following description for a buyer: “Find your realistic Buying Price! This is for Buyers who have found a house(s) of interest. Here you can easily determine if that house is priced right . . . if it's the deal you are looking for . . . and make sure you are not paying too much!”

An evaluator login area 1230 is provided for the transacting user 195 to either create a new account or login to a previously created account. The account setup (not shown) includes such key information as a username, password, and email address, and may include such additional information as address, phone number, desired property characteristics, and the like. The evaluator login area 1230 may also include a button for viewing a sample evaluation, so that the transacting user 195 who is considering opening an account may review a sample of the evaluator results before committing.

The evaluator query screen 1300 also includes a selection criteria area 1240, which contains a pulldown area selector 1241, a pulldown price range selector 1242, and a pulldown age range selector 1243. Illustrative values for these criteria are: Area Selector 1241: “All SW Reno.” Price Range Selector 1242: “1,500 Sq Ft.” Age Range Selector 1243: “1990-1999. Optional property worksheets 1250 and 1260 for a buyer and seller respectively are provided so that the address and MLS number of a specific property of interest may be added. The property address or MLS number is optional, since the evaluation may be performed based on the area, price range and age range selection criteria. However, if the property address or MLS number is provided, the real estate professional may use such information to further assist the buyer or seller. Illustratively, the real estate professional may have access to various tools and statistics modules not available to the public, which may be used to further assist the buyer or seller. Once the selection criteria are set, the transacting user may get the evaluation by selecting either the buyer's get evaluation button 1252 or the seller's get evaluation button 1262, as appropriate.

The evaluator results screen 1300 (FIG. 14) may include an evaluation results header 1320 which provides a title and general description of how the evaluator results may be useful. The selection criteria may be included if desired. Illustratively, the evaluation results header 1320 may contain the following description for a buyer: “The Evaluator helps a home buyer identify the deal they are looking for . . . and helps make sure they are not paying too much. Your Selected Criteria: All SW Reno, 1,500 Sq Ft, 1990-1999. Evaluation of an All SW Reno House (1,500 Sq Ft house built in 1990-1999).”

A house value and value range area 1330 provides the results of the evaluation, illustratively as follows: “House Value (based on comparable sales last 365 days): $177,599. Estimated Sales Range (range of your greatest possible success): $165,000-$190,000. The estimated sales range is an estimate of the range of the greatest possible success for the seller or buyer, based on a number of particulars and comparables which may be reported in a particulars area 1340 and in a sales success area 1360.

The particulars area 1340 provides more detailed information, such as, for example, the lowest sale price of a comparable home, the highest sale price of a comparable home, the lowest price per square foot value of comparable sales, the highest price per square foot value of comparable sales, the average price per square foot value of comparable sales, the average age of homes in the evaluation, the number of comparable home sales used in the evaluation, the number of comparable home sales BELOW the range of $165,000-$190,000, the percentage of comparable home sales BELOW the range of $165,000-$190,000, the number of comparable home sales within the range of $165,000-$190,000, and the percentage of comparable home sales within the range of $165,000-$190,000. This “out of range” information may be particularly interesting to buyers and sellers.

The evaluator results screen 1300 may also include an adjustments area 1350 which provides guidance on how to price within the range based on particulars of the specific property of interest to the buyer or seller. Illustrative guidance include the following: if the property need to be remodeled consider bottom of range; if the property is in really poor condition consider lowest sale price above; if the property has been remodeled in the last 5 years consider middle or top of range; if the property is in excellent condition consider top range to highest price above; if the property does not have a garage consider bottom of range; if the property has top appliances or a custom kitchen, consider top of range or near; if the property has hardwood floors or is recently painted consider middle to near top of range; and if the property is on a particularly large lot consider top of range. The adjustments area 1350 may include the estimated sales range for the convenience of the user, and may provide a modified range if the property in question is the nicest in town.

The evaluator results screen 1300 may also include a sales success area 1360 which obtains and consolidates information from a number of other applications in the application level 160 for giving the transacting user 195 a comprehensive view of other relevant information and analysis in, for example, areas 1361-1366.

Area 1361 is populated by the effect of listing too high application 165 to provide the median sold price in the estimated sales range for the specified selection criteria (illustratively All SW Reno, $165,000-$190,000, built in 1990-1999) for property sold in 90 days or less, and sold in 180 days or more. Interpretation sentences may also be provided, such as, for example, the following two: (1) “All SW Reno house that are listed too high in this price range are taking an average of 165 MORE days to sell, and they are selling $19,500 LESS than they would have if priced properly.” and (2) In taking 165 more days, or 5.50 MONTHS of additional mortgage payments, plus the cost of insurance and all other house costs, and losing $19,500 at the same time a wise home selling decision?”

On market right now area 1362 is populated by the characteristics by price/size application 162 to provide for the estimated sales range such information as, illustratively, the number of listings in the estimated price range right now (illustratively 35), and by the absorption rates application 161 to provide for the estimated sales range such information as, illustratively, the average number of sales per month over the last 365 days (absorption rate) (illustratively 2), and how long it will take to sell all listings at current absorption rate (demand) (illustratively 18 months).

Odds of selling success area 1363 is populated by the odds of selling application 164 to provide for the estimated sales range such information as, illustratively, the odds of selling and not selling in one year (illustratively 41% and 59% respectively), in six months (illustratively 68% and 32% respectively), and in ninety days (illustratively 100% and 0% respectively).

The “if you list too high” area 1364 is populated by the effect of listing too high application 165 to provide for the selected square foot range and years built such information as, illustratively, the square foot value of all homes sold, how much longer to sell if listed too high, and the difference in sold price if listed too high.

The cost of listing too high area 1365 reiterates how much longer to sell if listed too high, and provides the user an opportunity to invoke the house cost calculator application 167 via the button 1370 to determine the additional costs personal to the user of the extra time on the market.

Illustratively, spreadsheet and/or PDF files are offered to the transacting user 195 via download or email in an information request area 1370. The information request area 1370 is similar to the information request area 480 (FIG. 4), with the spreadsheets of sales and listings being for the selected area and price range.

Lead Generation

Because the manner, relevancy and succinctness of the information provided by the interactive real estate information resource system 100 is so unique and fully informs the buyer and seller and gives them a sense of accomplishment and self-confidence, the system is effective as a lead generation tool. Branding information for the real estate professional sponsoring the interactive real estate information resource system 100 may be present on every screen in an unobtrusive manner so that transacting user 195 may be reminded of the real estate professional and know how to contact the real estate professional. The user is invited to create a login account at any time, which includes the user's contact information so that the real estate professional may contact the user to discuss how best to be of service. Optionally, some or all of the applications in the application layer 160 may be made available only if the user creates an account and logs in. A required login is particularly suitable for use of the evaluator application 166, since so much powerful and useful information is generated and made available to the user.

Various screens invite the transacting user 195 to request certain files such as spreadsheet and PDF files for his or her future reference; see, for example, the set of information fields and buttons 470 (FIG. 4), 570 (FIG. 6), 670 (FIG. 7), 770 (FIG. 8), 970 (FIG. 10), 1070 (FIG. 11) and 1370 (FIG. 14). When the transacting user 195 makes such a request, the event and user email address is captured and available to the real estate professional. One suitable way is for the real estate professional to be blind-copied on any email that is sent in fulfillment of the request. Another suitable way is for the download or email event to be captured in a log, which the real estate professional may access at any time.

The broker/agent dashboard layer 190 may be provided with the capability of tracking all user activity, whether the user has a user account or not. The real estate professional may login to the broker/agent dashboard layer 190 to access the record of user activity for lead generation.

Administrative Tools

The MLS dashboard 180 works upon the standardized MLS data, and enables configuration of the basic logic of the various interactive tutorial modules 309 to adapt to the unique characteristics of and variations in the MLS data. The MLS dashboard layer 180 works via both back-end rules and via a graphic user interface to make custom adjustments relating to such factors as the area where homes are found; the price-range of homes; the size-range of homes, and the age of homes. The MLS dashboard layer 180 allows most necessary standardization adjustments to a particular MLS data set to be quickly, rather than have to process and code each MLS data set individually from the onset. The MLS dashboard layer 180 is most useful to a designated MLS specialist either employed or contracted by a real estate organization or a real estate professional. A suitably knowledgeable real estate professional may also be considered to be an MLS specialist.

The broker/agent dashboard layer 190 presents the interactive tutorial modules 309 to the real estate professional and allows for initial set up. It also allows the real estate professional to set up the “defaults” for the interactive tutorial modules 309, including home area, size, price and year built. It also allows for a broker or agent to apply their custom branding to the interactive tutorial modules, for lead generation.

As used in the description herein and throughout the claims that follow, the meaning of“a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An interactive real estate system comprising:
a standardization engine communicatively coupled with a plurality of MLS databases and configured to:
receive at least two sets of raw MLS data from at least two MLS databases, wherein the at least two sets of raw MLS data different in format;
convert the first and second sets of raw MLS data into a standard format;
store the standardized first and second sets of raw MLS data on an standardized MLS database comprising a non-transitory electronic storage medium;
an application engine configured to calculate at least one attribute of the standardized first and second sets of raw MLS data.

2. The system of claim 1, wherein the attribute comprises an absorption rate.

3. The system of claim 1, wherein the attribute comprises one of a price characteristic and a size characteristic.

4. The system of claim 4, wherein the attribute wherein the price characteristic and a size characteristic comprises one or more of: average age, oldest age, youngest age, average square feet, smallest square feet, largest square feet, average price per square foot, least price per square foot, greatest price per square foot, total number of sales, total number of bank-owned sales, total number of short sales, total number of distress sales, percent of distressed sales, average time to sell, shortest time to sell, and longest time to sell.

5. The system of claim 1, wherein the attribute comprises a deal rating.

6. The system of claim 5, wherein the deal rating is based in part on a user selection.

7. The system of claim 1, wherein the attribute comprises an estimated odd of selling.

8. The system of claim 7, wherein the estimated odd of selling is calculated as a ratio of a total number of homes sold to a total number of homes listed for a given geographical area and temporal period.

9. The system of claim 1, wherein the attribute comprises an estimated effect of listing a property at a higher price relative to a lower price.

10. The system of claim 1, wherein the effect comprises at least one of (i) a period of time representing an estimation of how much longer it will take to sell the property at the higher price relative to the lower price and (ii) a price representing an estimation of a difference between a first sold price associated with the higher price and a second sold price associated with the lower price.

11. The system of claim 1, wherein the attribute comprises an evaluator characteristic comprising one or more of: house value, spread based on median sold price, estimated sale range, lowest sales price of comparable home, highest sales price of comparable home, lowest price per square foot, highest price per square foot, average price per square foot of all comparable sales, average age, number of comparable homes in an evaluation query, comparable home sales below an estimated sales range, comparable home sales within an estimated sales range, comparable home sales above an estimated sales range, median sold price of all sales within an estimated sales range.

12. The system of claim 11, wherein the evaluator characteristic is specific to one or more of a square foot range, year built range, and time period.

13. The system of claim 1, wherein the attribute comprises a house cost calculation.
